(19) United States
(12) Patent Application Publication
(10) Pub. No.: US 2008/0192424 A1
(43) Pub. Date: Aug. 14, 2008

(54) Laptop computer supporting device

(76) Inventor: Chung-yi Lee, Taipei (TW)

Correspondence Address: LEE, CHUNG-YI, 3F.,NO.4-1, Lane 61, Zhiyuan, 2nd Rd., Beitou, TAIPEI, 112, omitted

(21) Appl. No.: 12/068,254

(22) Filed: Feb. 5, 2008

(30) Foreign Application Priority Data
Feb. 8, 2007 (TW) 096202585

(51) Int. Cl. G06F 1/16

(52) U.S. Cl. 361/683

(57) ABSTRACT

A laptop computer supporting device for use both on desktop and on user's lap, comprising a back plate detachably attached to the computer's bottom, a set of arms pivotally connected to said back plate and a long board, whereby said long board rises variably away from the computer; a set of control components, functioning in conjunction with a controlling means consisted in said back plate, for adjusting the extent to which said long board rises such that the tilting angle of the computer's keyboard can be selected. Said back plate provides plural holes to receive fasteners, such as snap fasteners, which are to be bonded to the computer's bottom; alternatively, removable adhesive products can be used instead of such fastener; in either case, the device according to this invention is detachable from the computer when desired. Said long board has a width to provide comfort when resting on user's lap.

### BACKGROUND OF THE INVENTION

This invention relates to the improved device for elevating and tilting a laptop computer, particularly one such device that is removably installed to be virtually integrated with the computer as one. Herein the terms ‘laptop computer’ is used in a broad sense to include tablet PC or similar apparatus.

Regarding the method and devices designed to support, in particular to elevate the keyboard of a laptop computer, patents have been issued to various inventions, wherein substantial reasons such as for enhancing heat dissipation or lifting the screen closer to the level of the user's eyes have also been interpreted. Though designed to work with a laptop computer, part of prior art inventions, e.g., devices according to Taiwan Patents No. 397481 granted to Aidma Enterprise Co. in 1999, and No. M292106 granted on Nov. 6, 2006 to S. Huang, are intended for use only on desk, even only at one place. The former, of “A rack for portable computer”, discloses a stand for a portable computer, with a wrist rest near the end of the sloped top plate, featuring arc shaped body in the design of visual pleasure when working with such state-of-the-art product as notebook computer. Such device does raise a laptop computer, but at a fixed position, and it is not suitable for carrying around. The latter, of “Angle adjuster for laptop computer”, discloses a device comprising a base, a leg, which has one end pivotally connected to said base, able to swing thereinto to be stowed and out thereof to support the laptop computer at an angle, and an adhesive member, or a piece of Velcro tape, for attaching said base to the computer's bottom, and integrate the two devices as one. However, by “angle adjuster” it actually raises a laptop computer at only one angle, and being only one small piece of leg, it is impossible to place such device on user's lap. There is also U.S. Pat. No. 4,044,980, therein the L-shaped structure consisted in such a supporting device, which if adapted to be used for supporting a laptop computer, can hinder the operation of the buttons, ports or indicator lights which are disposed on the computer's end that faces the user.

In addition, though such a device according to said U.S. Pat. No. 4,044,980 provides frictional material to resist sliding of an object, especially a heavy object like laptop computer, there on, there is no guarantee that the object never falls off such supporting device during transporting. Theoretically, and also practically, most devices according to these inventions can be made to be light as well as thin enough to comply with the characteristic of a laptop, which is compactness. But all are not fully adjustable in the height of the elevation. An example is the Support Device For A Laptop computer according to U.S. Pat. No. 5,3379,85. Also, they may be adding handling procedures to starting to use of a laptop computer, for example, devices according to Taiwan Patents No. 412021 granted to G Huang on No. 11, 2000 and No. 499149 granted on No. 8, 2002 to Chen-Cource Inc., because they are not integrated with the laptop computer. The former, of “Auxiliary rack for portable computer”, comprises a scissors-like disposed pair of pipes, each having two ends, of which at least one is open and accommodates a rod that slides therefrom like a telescope and is controlled by a screw disposed at said open end of the pipe and driving in the direction of the pipe's radius; and a plurality of support blocks, each one disposed, perpendicularly, at the outreaching end of each said rod for supporting and elevating the portable computer when said pipes are flatly deployed. The latter, a “Fixing rack for notebook PC”, is another scissors-like linking bars for supporting a notebook PC, characterized in that both bars are designed in particular shapes with step and recess in the middle such that they complement each other when stowed and define a position, by means of a pin provided on one bar disposed inside an axial hole provided in the other bar, when deployed, aiming to reduce the cost of components. Both bars have a sloped top surface to tilt a laptop computer placed on top of the device.

There may be a great part of the laptop users constantly on the move using their laptop PCs. They may feel carrying an extra apparatus cumbersome, not to mention handling it into and out of a bag, deploying it and collapsing it every time. Among past inventions, the methods like ‘Laptop computer system with elevating port cover’ proposed in U.S. Pat. No. 6,002,581 are important in the aspect that they advise the computer manufacturers to adopt and produce computers with such improvement in respect to elevating the keyboard of a laptop-computer. However, to date such products have hardly been seen. That reveals the drawback of an invention being dependent upon the computer manufacturer's willingness to adopt. Moreover, the extent of elevation by such type of devices would be very limited. Therefore, inventions proposing third-party products, including one made in accordance with the present invention, could be better justified as being implementable. Consequently, a laptop elevating device that is easy to carry and quick to deploy in conjunction with the laptop; or rather, and particularly, a device that is virtually integrated with the laptop computer would be most desirable.

And examples of implementing such concept in a similar manner do exist. One is U.S. Pat. No. 5,337,985 issued to Hale back in 1994, wherein disclosed is a set of V-shaped displaced panels with an end of each panel attached by means of hook-and-loop material to the bottom surface of a laptop to elevate it. Such a simple and non-fixed structure can be accredited an advantage. However, said invention has the drawback that it forms only one angle, which is approximately 90 degrees, meaning that the height of elevation it creates is fixed. Plus, such invention would need to carry out twice the deployment. It is therefore the object of the present invention to provide an elevating device for laptops that complies with the requirement of being compact, and is adjustable in a wide range of angles of elevation.

### SUMMARY OF THE INVENTION

The object of the present invention is to provide an elevating device for laptops that is both light and compact, and is adjustable in a wide range of angles of elevation. It is another object of the present invention to provide such elevating devices that are integrated with the laptop computer and are quick to deploy and stow.

It is better for a laptop computer supporting device not to have a computer holding member of the afore-mentioned L-shaped structure disclosed in U.S. Pat. No. 4,044,980, for the reason also explicated above. Also, without an L-shaped structure, the whole device can be more compact. Hence, in the supporting device, the computer-mounted member(s) must be able to hold the laptop in place, and do without an L-shaped structure. This can be done by having this part of member(s) and the bottom of the laptop firmly joined as explicated by preferred embodiment of the present invention described in the below sections. However, the object hereof is not simply to permanently affix said member(s) to the laptop's bottom. Rather, said members are desired to be removably attached to the bottom of the laptop. To this end, the present invention provides a means of using a plurality of fastening members, which are to be bonded to the bottom surface of the laptop, or alternatively fastening products, to hold said computer-mounted member(s) of the device firmly to said bottom surface.

It is yet another object of the present invention to provide a longest flat member that has a width, such that a device according to the present invention is suitable for use with the laptop computer on one's lap.

### BRIEF DESCRIPTION OF THE DRAWINGS

FIG. 1A shows the device of a first preferred embodiment according to the present invention.

FIG. 1B illustrates the device disclosed in FIG. 1A in service after being installed onto a laptop computer.

FIG. 2A and FIG. 2B show the steps of installing the device disclosed in FIG. 1A on a laptop computer.

FIG. 2C illustrates the device disclosed in FIG. 1A completely installed and fully slowed.

FIG. 3A illustrates a second preferred embodiment according to the present invention. The status is prior to installation.

FIG. 3B enlarges a part of the member 10 as shown in FIG. 3A to illustrate its release of a strap member 35.

FIG. 4A shows the device of the preferred embodiment as shown in FIG. 3A after installation onto a laptop and stowed.

FIG. 4B shows the same device deployed to an extent.

FIG. 4C illustrates the deployed device in service of a laptop computer.

### DETAILED DESCRIPTION OF THE PREFERRED EMBODIMENTS

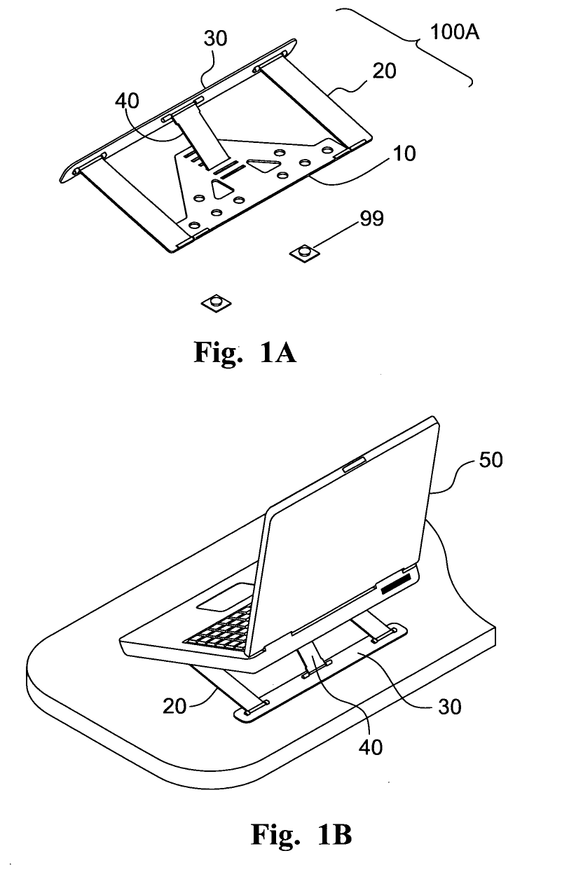

Reference is made to FIG. 1A wherein disclosed is a device of a first embodiment according to the present invention prior to installation. FIG. 1B shows an example of use of such device with a laptop computer. The nature and substance of such device can be understood by the description of its installation in steps.

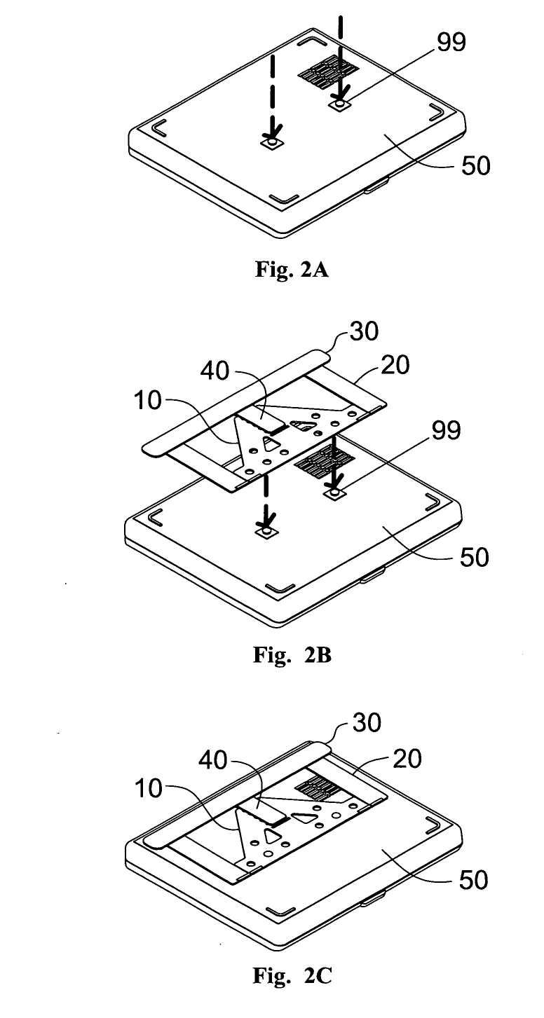

Reference is now made to FIGS. 2A, 2B and 2C, wherein the shown device is the same as disclosed in FIG. 1A. FIG. 2A illustrates the initial step of bonding a plurality of fastening members (99) onto the bottom surface of a laptop, as the dotted lines indicate. FIG. 2B illustrates a subsequent step of disposing the device onto the bottom surface of the laptop as the diagrammatic arrows indicate, so that the device is attached, indirectly, via said fastening members (99), to the laptop's bottom. FIG. 2C shows the completion of the aforementioned installation, with the device in fully stowed position. Wherein, said fastening members (99) are designed to provide detachable fastening like a snap fastener, it would not be difficult to understand that the device, except said fastening members (99), can be detached from the computer. Also, it would not be difficult to understand from FIG. 1A that the device is adjustable in its deploying angles thanks to the propping mechanism (20, 40) consisted in it.

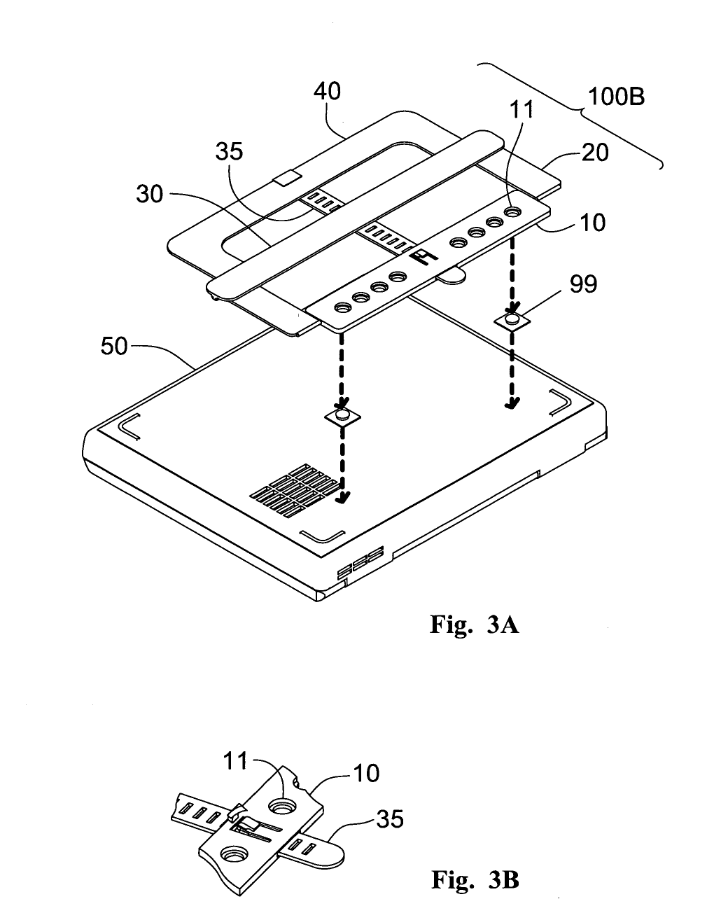

In order that the embodiments become clear in details, reference is now made to FIG. 3A, wherein a second version is disclosed. The illustrated status of the device is prior to installation onto the laptop. Similarly, a hinged structure comprising mainly members 20 and 30 is provided. The member 10, a back plate, to which said members 20 are pivotally coupled, is to be attached to the bottom of the laptop by use of fastening members (99), and can be detached therefrom whenever desired. Said members 99 are to be affixed, by user, to the bottom surface of the laptop, with adhesive, for example.

In laptop computers, the layouts of screws, covers and vents on their bottom are sure to be different from one model to another. As a result, one model of laptop will require different allocation of said fastening members 99 from that on others, with a view to avoid blocking any screw hole or any vent. For this purpose, the back plate (10) is designed to provide as many holes as possible to receive said fastening members 99 which are differently allocated depending on different computer models.

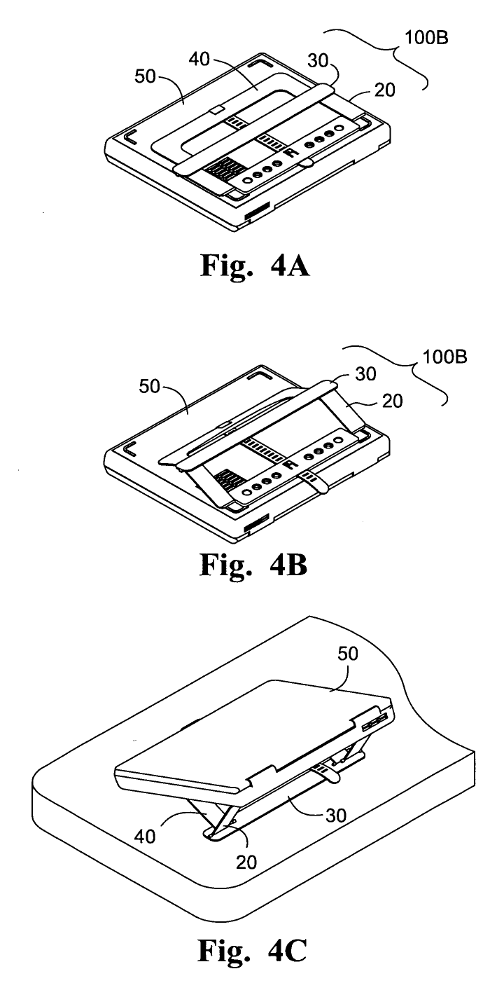

Reference is still made to FIG. 3A, wherein said member 10 provides axles through which members 20, which are a set of arms, on one end are pivotally coupled thereto. Members 20, on the other end, are pivotally coupled to member 40, to which member 30, a long flat board, is also pivotally coupled. This group of members 20, 30 and 40 are free to rotate, whereby member 30 is rising away from the computer's bottom surface, as shown in FIG. 4B.

Reference is still made to FIG. 3A, wherein member 35 is a multiple-grooved strap with one end attached to member 40, and the other end stretching through and adjustably buckled up by a mechanism contained in said member 10, as illustrated in FIG. 3B which enlarges part of member 10 to show the mechanism releasing its buckling up of the strap (35), such that a variety of triangular configurations of said members 20, 30 and 40 can be obtained. In this manner, various heights of said long flat board (30) will be achieved and maintained. On the strap (35), the grooves can be replaced by multiple of teeth.

Reference is now made to FIG. 4A, 4B and 4C, wherein different status of deployment of the device of this second embodiment after installation are shown. In FIG. 4A, the device is seen stowed away; in FIG. 4B, the device is seen deployed at an angle. In FIG. 4C, the long flat board (30) is finally seen resting on a level surface, with the deployed device supporting the computer. This whole set of apparatuses (the supporting device and the computer) can be relocated onto user's laptop easily, without the concern about the laptop falling off the supporting device—a characteristic of the present invention. Said member 30 is designed to be longest as well as with a width, such that it helps eliminate otherwise possibly caused discomfort to user's lap by the computer's weight through narrow part area over a period of use.

Hence, another characteristic of the present invention becomes evident: the device according to the present invention is suitable for use on desktop as well as on top of user's lap.

It is yet another advantage of the present invention that the supporting device is detachable. The whole device according to the present invention, except said fastening members that are user-bonded to the computer, can be detached from the laptop when needed. The aforementioned methods of removably attaching the devices to the laptop computer according to the present invention should not be limiting when explicating the detachable characteristic of the present invention. Any one skilled in this art would have no difficulties finding other means or methods to implement this characteristic. Being characteristic of this feature, the device can be detached from the laptop in case the latter needs repairing, and thus will not constitute obstacle to such servicing. Or, if replacement parts for said fastening members are provided, then, when the existing laptop is replaced or no longer in use, the existing set of device can be transferred to serve a new laptop by affixing new fastening members thereto.

Alternatively, removable adhesive products, e.g., double-sided tape, can be used in lieu of said fastening member to attach said back plate directly to the laptop's bottom.

A further characteristic of the present invention is about handling. One who frequently travels around using his laptop computer would feel taking out two objects from the carrying bag every time less convenient than just one object. Not to mention the bothering to properly dispose the computer on the device after deploying it, particularly with the aforementioned U.S. Pat. No. 5,337,985 that takes twice the deploying steps. In this sense, a device which is integrated with a laptop in accordance with the present invention is more advantageous than other types of laptop elevating devices. With a few times of practice, a user would be able to deploy such a device as desires and quickly, without needing to flip the laptop upside down.

What is claimed is:

1. A foldable device for supporting a laptop computer, comprising:
a back plate, which is a flat board provided with a plurality of holes of the same size, removably attached to the bottom of the laptop computer, and including a controlling mechanism;
a set of arms, each having a first end pivotally connected to said back plate, and a second end opposite to said first end, which swings freely thereabout;
a long flat board having width, pivotally connected to said second ends of said arms, for placing on top of lap;
a set of controlling components, of which at least one component having one end pivotally connected to said long flat board, whereby the engagement of said controlling components with the controlling mechanism of said back plate is used to adjust the angle of deployment of said arms;
whereby the laptop computer is supported, with its distal end to user elevated at any selected angle.

2. A foldable device for supporting a laptop computer as claimed in claim 1, wherein said back plate is in the shape of frame to minimize the weight and facilitate heat dissipation of the computer.

3. A foldable device for supporting a laptop computer as claimed in claim 1, wherein said back plate is detachably attached to the computer's bottom by means of the engagement and disengagement of holes therein with a plurality of snap fastener-like fastening members which are glued to the bottom surface of the computer.

4. A foldable device for supporting a laptop computer as claimed in claim 1, wherein said back plate is detachably attached to the computer's bottom by means of at least one removable double-sided adhesive product.
